(19) United States
(12) Patent Application Publication
(10) Pub. No.: US 2016/0125062 A1
(43) Pub. Date: May 5, 2016

(54) MULTI-SCALE TIMELING PHOTOGRAPH ALBUM MANAGEMENT WITH INCREMENTAL SPECTRAL PHOTOGRAPH CLUSTERING

(71) Applicant: Futurewei Technologies, Inc., Plano, TX (US)

(72) Inventors: Kolbeinn KARLSSON, Ithaca, NJ (US); Wei JIANG, Belle Mead, NJ (US); Dongqing ZHANG, Plainsboro, NJ (US)

(21) Appl. No.: 14/528,829

(22) Filed: Oct. 30, 2014

(51) Int. Cl. G06F 17/30

(52) U.S. Cl. CPC G06F 17/30598; G06F 17/30247

(57) ABSTRACT

Described embodiments utilize a multi-scale timeline approach in which photographs in a photograph album are organized into photograph clusters associated with multiple timeline scales. Each photograph cluster can be represented on a display screen as a thumbnail indicator in a photograph album window for efficient browsing. The thumbnail indicator can comprise one or more images automatically selected to represent a large number of photographs from the photograph cluster. Activation of one of the thumbnail indicators can trigger a change to another timeline scale. A multi-scale timeline one-step incremental spectral photograph clustering algorithm can also be utilized to quickly add or delete photographs from the cluster photographs at multiple timeline scales with a complexity approaching O(n). Near-duplicate photographs can also be automatically detected based on both time and visual features, and collapsed to a single representation to save space on the relatively small display screens typically included in mobile devices.

### TECHNICAL FIELD

The present disclosure relates generally to the field of photograph album management on a mobile device.

### BACKGROUND

The prevalence of high-quality cameras in mobile devices with ever increasing storage capacity has given rise to an explosion in the amount of photographs being taken and stored by mobile devices making effective on-device photograph management increasingly important. Traditional attempts at mobile photograph browsers (e.g., on iOS systems, Android systems, etc.) are typically similar to conventional photograph browsing attempts found in conventional personal computers (PCs) (e.g., where photographs in a folder are presented in a flat grid-based view). However, such conventional browser attempts are not readily adaptable for use in mobile devices.

The basic form factor of most mobile devices being relatively compact may be beneficial for mobility but often limits other capabilities of the mobile devices. Mobile devices normally have small display screens, and it can be very hard for users to browse through a large photograph album to locate individual photographs. Attempts at presenting large numbers of photographs in a “flat” presentation on the small screen is not typically efficient for on-device photograph browsing in a mobile device. Attempts that try to include numerous photographs often result in the images being too small and attempts to use larger images result in far to few being presented at a time for efficient browsing. Some convention approaches may also attempt to convey the photographs' time order in a browsing system, but simply laying out a large number of photographs in a flat timeline with a single timeline scale does not typically offer an improvement. Again, the limited display area usually means only a small portion of the photographs can typically be displayed at one time, and the single timeline scale is often even harder than the grid-based view for a user to swipe through the large photograph album to locate photographs of interest.

There are a number of conventional attempts (e.g., made on conventional PCs, etc.) that are not typically practical for use in mobile devices. For example, systems like Time Quilt and Photographland attempt to organize photographs based on visual features and metadata. Other systems like PhotographMesa and PhotographFinder focus on screen lay-out and/or user queries. Commercial solutions like Apple's iPhotograph and Google's Picasa rely heavily on user tags and manual sorting. Some conventional on-device presentation approaches attempt to arrange photographs on non-uniform grids on three-dimensional structures. Some other conventional attempts aim at both photograph organization and presentation by photograph grouping based on time, faces, and background features. However, the photograph grouping result is still presented in an inflexible grid-based view or a simple flat timeline. Again, these conventional attempts can typically be very inefficient and unpractical in dealing with large numbers of photographs (e.g., in photograph albums) in a mobile device platform.

### SUMMARY OF THE INVENTION

Described embodiments utilize a multi-scale timeline approach. Photographs in a photograph album are organized into photograph clusters associated with multiple timeline scales (e.g., corresponding to years, months days, hours, etc). Each photograph cluster can be represented on a display screen as a thumbnail indicator in a photograph album window for efficient browsing. The thumbnail indicator can comprise one or more images automatically selected to represent a large number of photographs from the photograph cluster. Activation or triggering of one of the thumbnail indicators can trigger a change to another timeline scale. To accommodate the limited processing power in mobile devices, a multi-scale timeline one-step incremental spectral photograph clustering algorithm can also be utilized to quickly add or delete photographs from the cluster photographs at multiple timeline scales with a complexity approaching O(n). To further improve browsing efficiency, near-duplicate photographs can be automatically detected based on both time and visual features, and collapsed to a single representation to save space on the relatively small display screens typically included in mobile devices (e.g., a mobile phone, mobile tablet, etc.).

In one embodiment, an apparatus comprises a processor that automatically builds a plurality of photograph clusters that are associated with a plurality of timeline scales which are adjustable, a memory that stores information and instructions associated with a photograph album, and a display that presents the information associated with the photograph album including a photograph album browse window. The inclusion of a photograph in one of the plurality of photograph clusters is determined at least in part by a time an image is captured in the photograph and the plurality of timeline scales. The processor can also initiate presentation of information associated with the photograph album in accordance with at least one of the plurality of photograph clusters. The presentation of the photograph browse window includes at least one thumbnail indicator that is operable to trigger a switch from a first one of the plurality of photograph clusters associated with a first one of the plurality of timeline scales to at least a second one of the photograph clusters associated with a second one of plurality of timeline scales. The apparatus can be a mobile device.

A photograph clustering method in a mobile device can include receiving an indication to initiate a photograph cluster configuration in a processing device; configuring photographs automatically into photograph clusters; and reconfiguring automatically at least a first portion of the photograph clusters. Configuring photographs automatically into photograph clusters is performed in response to receiving the indication to initiate photograph clustering. The configuring is performed by the processing device in accordance with a first photograph clustering process, wherein the photograph clusters are associated with a plurality of timeline scales and which of the timeline scales is active is adjustable. The reconfiguring is directed to a first portion of the photograph clusters that is impacted by insertion of an additional photograph. The reconfiguring can be performed in accordance with a second photograph clustering process that is incrementally directed to the first portion of the photograph clusters without performing reconfiguration operations on a second portion of the plurality of photograph clusters that is not impacted by the insertion of the additional photograph.

Photograph clustering can be performed in a mobile device comprising a processor that organizes a photograph album within a multi-scale timeline framework that includes a plurality of timeline scales, a memory configured to store information and instructions associated with a photograph album; and a display configured to present a user interface in accordance with directions from the processor. Photographs in the photograph album are configured into a plurality of photograph clusters and granularity of a resulting configuration of the photograph album into the plurality of photograph clusters corresponds to the granularity of the plurality of timeline scales. The user interface includes a thumbnail indicator configured to enable a user to initiate a switch between one of the plurality of timeline scales to another one of the plurality of timeline scales and correspondingly change association of the thumbnail indicator from one of the plurality of photograph clusters to another one of the plurality of photograph clusters. Additional explanation of various aspects of the new photograph album management and browsing approaches is set forth in the detailed description.

### BRIEF DESCRIPTION OF THE DRAWINGS

The accompanying drawings, which are incorporated in and form a part of this specification, are included for exemplary illustration of the principles of the present invention and not intended to limit the present invention to the particular implementations illustrated therein. The drawings are not to scale unless otherwise specifically indicated.

FIG. 1 is a block diagram of an exemplary mobile system in accordance with one embodiment.

FIG. 2 is a block diagram of an exemplary photograph browsing method in accordance with one implementation.

FIG. 3 is a block diagram of an exemplary photograph cluster configuration.

FIG. 4 is an illustration of exemplary changes in a photograph album window as different levels or timeline scales are activated.

FIG. 5 is an illustration of other exemplary changes in a photograph album window as different levels are activated.

FIG. 6 is an block diagram illustration of an exemplary collapsed down photograph cluster set.

FIG. 7 is a flow chart of an exemplary photograph clustering method in accordance with one embodiment.

FIG. 8 shows a graph of an example speed comparison of incremental photograph clustering and batch photograph clustering when one photograph is added.

FIG. 9 is a block diagram of an exemplary apparatus in accordance with one implementation.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments of the present disclosure facilitate efficient and effective management of photographs in a mobile device. The new photograph cluster approach facilitates enablement of a number of applications (e.g., photograph browsing, searching, etc.). A new multi-scale timeline is described, where photographs are grouped into photograph clusters in accordance with multiple timeline scales (e.g., corresponding to years, months days, hours, etc). In one exemplary implementation, photographs can be grouped into a first set of photograph clusters in accordance with a first timeline scale (e.g., based upon the year the photograph was taken or captured, etc.) and the photographs can be also grouped into another set of photograph clusters in accordance with a second timeline scale (e.g., based upon the month the photograph was taken or captured, etc.). In one embodiment, photograph clusters are associated with thumbnail indicators and the thumbnail indicators are displayed sequentially in a timeline fashion with adjustable timeline scales, enabling multi-scale timeline overview of the photograph album for efficient browsing. The thumbnail indicators can be presented in a user interface (e.g., on a touch screen of a mobile device, etc.) enabling a user to make adjustments to the timeline scale and browse the photograph album (e.g., using pan gestures, flick gestures, tapping gestures, etc.). The new approach facilitates efficient and quick browsing granularity adjustments in accordance with the new control and selection between multiple timeline scales, thereby enabling effective focus on photographs of interest while also facilitating effective bypassing of numerous photographs not of particular interest.

A new photograph cluster approach can also facilitate efficient and effective management and coordination of additions and deletions to photograph clusters. An incremental photograph clustering approach can be utilized when photographs are added or deleted from a photograph album. An incremental photograph clustering approach can include spectral photograph re-clustering operations that are incrementally performed for photograph clusters. Incremental photograph cluster operations can be performed for photograph clusters that are impacted by an addition or deletion of a photograph and full spectral photograph clustering operations are not performed for photograph clusters not impacted by the addition or deletion of a photograph. Additional explanation of various aspects of the new photograph album management and browsing approaches is set forth in later portions of the detailed description.

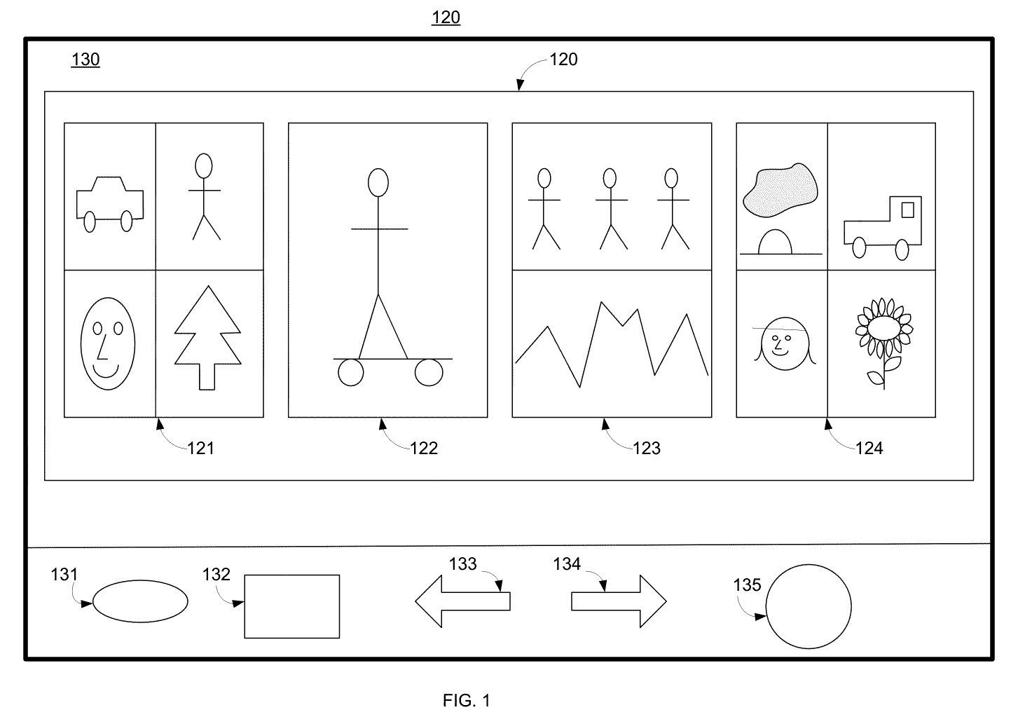

FIG. 1 is a block diagram of exemplary mobile system 100 in accordance with one embodiment of the present invention. Mobile system 100 includes display 110 and control buttons 131, 132, 133, 134 and 135. Control buttons (e.g., 131, 132, etc.) are configured to enable a user interface through which a user can input or initiate various instructions (e.g., return to a previous screen display, search, pull up various command icons on the display, etc.). Display 110 includes photograph album browsing window 120 which includes thumbnail indicators 121, 122, 123, and 124. A thumbnail indicator is associated with a portion or photograph cluster of the photographs included in a photograph album. Which photographs are included in a photograph cluster can be based at least in part upon a timeline scale. In one exemplary implementation, activation of a thumbnail indicator (e.g., finger “tap” on thumbnail indicator 121, selecting with control buttons 131 though 135, etc.) can activate or trigger a change between multiple timeline scales (e.g., change the timeline scale from year to month, month to days, etc.).

The photograph album window can be associated with a plurality of timeline scale levels (e.g., different timeline scales, etc.). A different level or timeline scale is activated or triggered by a thumbnail indicator at another level. A level or timeline scale can be associated with at least one thumbnail indicator and the thumbnail indicator is associated with a portion of the photograph album information. The thumbnail indicator is also associated with a timeline scale related to a portion of the photograph album information. Activation of a thumbnail indicator results in the timeline scale associated with the thumbnail indicator becoming the active timeline scale of a photograph album window.

In one exemplary implementation, a timeline scale is a year and photographs taken or captured within a first year are associated with thumbnail indicator 121, photographs taken or captured within a second year are associated with thumbnail indicator 122, and so on. In one example, the first year is 2010 and a finger “tap” on thumbnail indicator 121 triggers a change between a yearly timeline scale and a monthly timeline scale, wherein photographs taken or captured within one of the months in 2010 (e.g., March, etc.) are associated with thumbnail indicator 121, photographs taken or captured in another month (e.g., July, etc.) are associated with thumbnail indicator 122, and so on.

At least one photograph representative of a photograph cluster can be displayed in a respective thumbnail indicator. As illustrated in the example shown in FIG. 1, thumbnail indicator 121 can include photographs of a car, a person, a face, and a tree. Thumbnail indicator 122 can include a photograph of a person riding a skate board. Thumbnail indicator 123 can include a photograph of a group of people and a mountain range. Thumbnail indicator 124 can include photographs of a sunset and cloud, a truck, a person with a hat and a flower. Additional explanation of various aspects of new photograph clustering approaches is set forth in later portions of the detailed description.

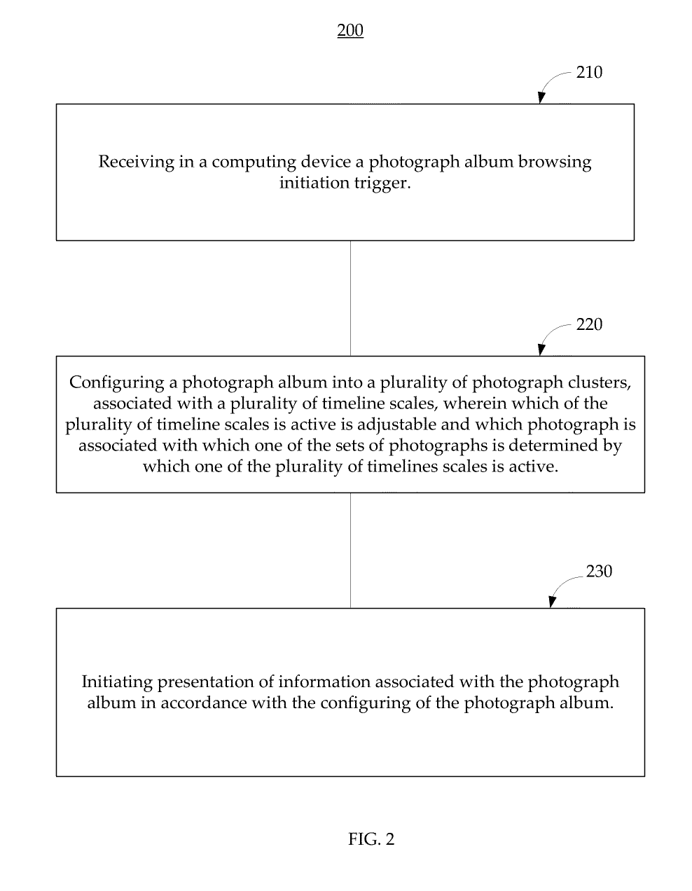

FIG. 2 is a block diagram of a photograph browsing method 200 in accordance with one embodiment of the present invention. Photograph browsing method 200 can be implemented in a mobile device. Photograph browsing method 200 can be utilized to enable efficient and convenient review and search of numerous photographs.

In block 210, a photograph album browsing initiation trigger is received. The initiation trigger can be received in computing device (e.g., a mobile device, a tablet, a mobile phone, etc.).

In block 220, a plurality of photograph clusters that are associated with a plurality of timeline scales are built. The inclusion of a photograph in one of the plurality of photograph clusters is determined at least in part by a time an image is captured in the photograph and the plurality of timeline scales. The inclusion of a photograph in one of the plurality of photograph clusters can be performed in accordance with a variety of photograph clustering approaches (e.g., full photograph cluster process, incremental photograph cluster process, etc.) and can be based upon a variety of factors (e.g., time, visual content, etc.). The timescales are adjustable. In one exemplary implementation, the photograph is included in a photograph album. The processor can also initiate presentation of information associated with the photograph album in accordance with at least one of the plurality of photograph clusters. Additional explanation of various aspects of the new photograph clustering approaches is set forth in later portions of the detailed description.

In block 230, presentation of information associated with the photograph album is initiated. In one embodiment, a photograph album browse window is associated with the photograph album, wherein the photograph browse window includes at least one thumbnail indicator that is operable to trigger a switch from a first one of the plurality of photograph clusters associated with a first timeline scale to at least a second one of the photograph clusters associated with a second timeline scale. Additional explanation of various aspects of the presentations or displays is set forth in later portions of the detailed description.

The new approach includes a multi-scale timeline framework to effectively organize and browse photographs. Each timeline scale corresponds to a level of granularity and the photograph album is partitioned or organized into photograph clusters in accordance with the level of granularity. The multi-scale timeline provides multiple granularities to organize photographs, where users can quickly switch among different timeline scales which in turn enables examination of different levels of granularity or details of the photograph album. The photograph clustering and corresponding thumbnail indicators are compatible with many of the characteristics of a mobile device and enable efficient on-device mobile photograph browsing,

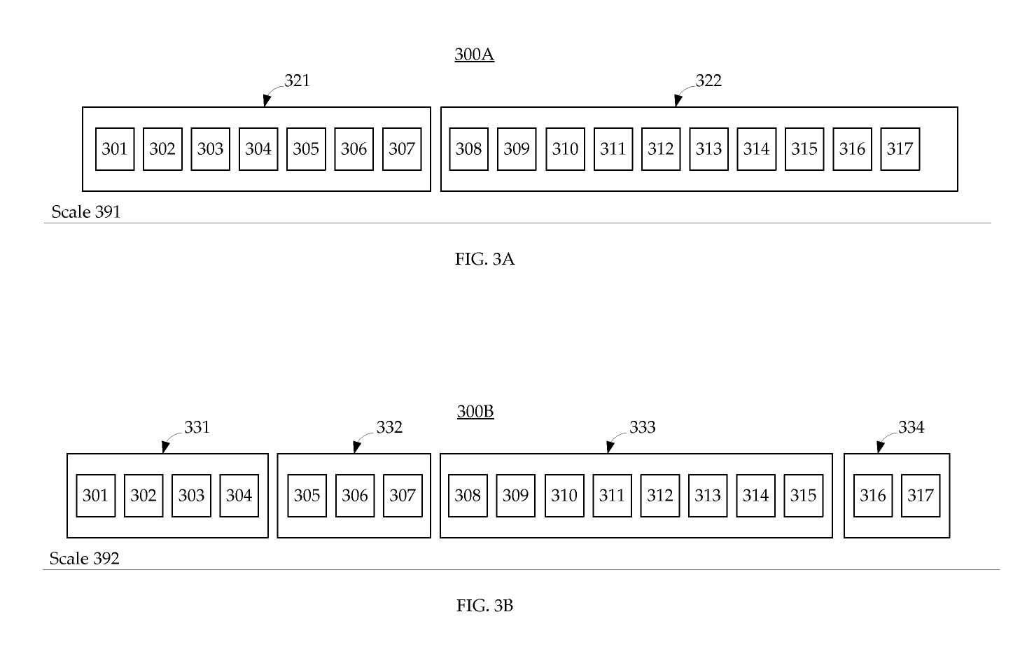

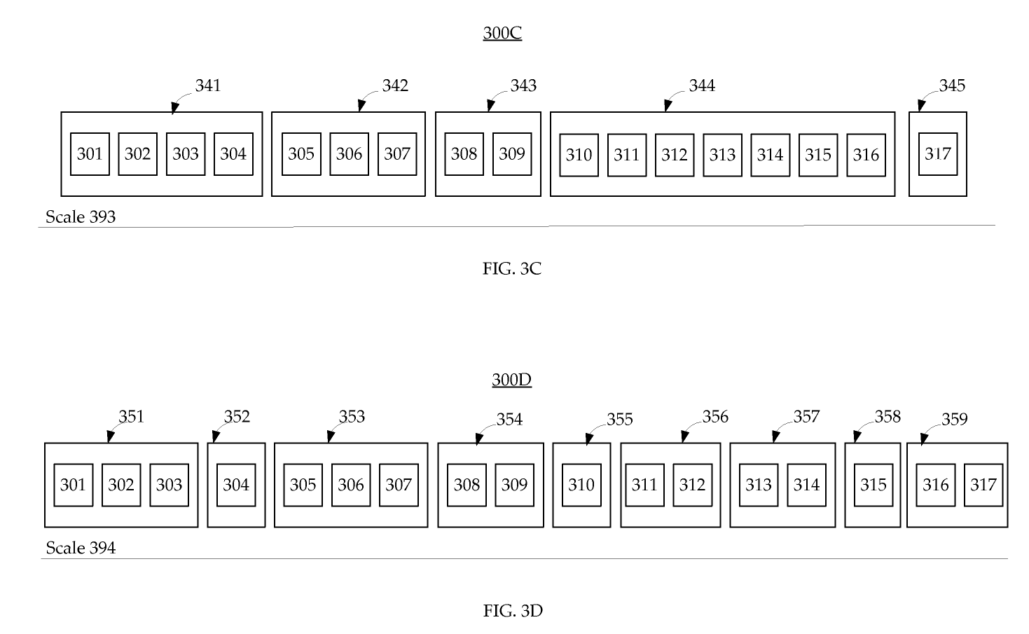

FIG. 3 is a block diagram of an exemplary photograph cluster configuration 300 in accordance with one embodiment of the present invention. Photograph cluster configuration 300 includes photograph clusters configured in accordance with timeline scales 391, 392, 393 and 394. Each of the timeline scales is associated with a different unit or span of time. In one exemplary implementation, timeline scale 391 is in years, timeline scale 392 is in months, timeline scale 393 is in days and timeline scale 394 is in hours. Photograph cluster 321 can include photographs associated with one year (e.g., photographs captured in 2000, 2010, etc.) and photograph cluster 322 can include photographs associated with another year (e.g., photographs captured in 2001, 2011, etc.). Photograph clusters 331, 332, 333 and 334 can include photographs associated with different months (e.g., photograph cluster 331 can include photographs captured in January, and photograph cluster 332 can include photographs captured in July, etc.). Photograph clusters 341, 342, 343, 344 and 345 include photographs associated with different days (e.g., photograph cluster 341 can include photographs captured on a particular Monday and photograph cluster 342 can include photographs captured on a particular Friday, etc.). Photograph clusters 351 through 359 include photographs associated with different hours (e.g., photograph cluster 351 can include photographs captured between 11:00 AM and 1:00 PM and photograph cluster 353 can include photographs captured between 3:00 PM and 7:00 PM, etc.).

It is also appreciated that in addition to changes in units of time, an adjustment in a timeline scale can also be directed at a span of time. In one embodiment, photograph cluster 353 can include photographs captured between 3:00 PM and 7:00 PM and in response to a trigger (e.g., reversing pinching or expanding motion on the thumbnail indicator, etc.) another group of photograph clusters can be configured in which one photograph cluster can include photographs captured between 3:00 PM and 4:00 PM and another photograph cluster can include photographs captured between 4:00 PM and 5:00 PM.

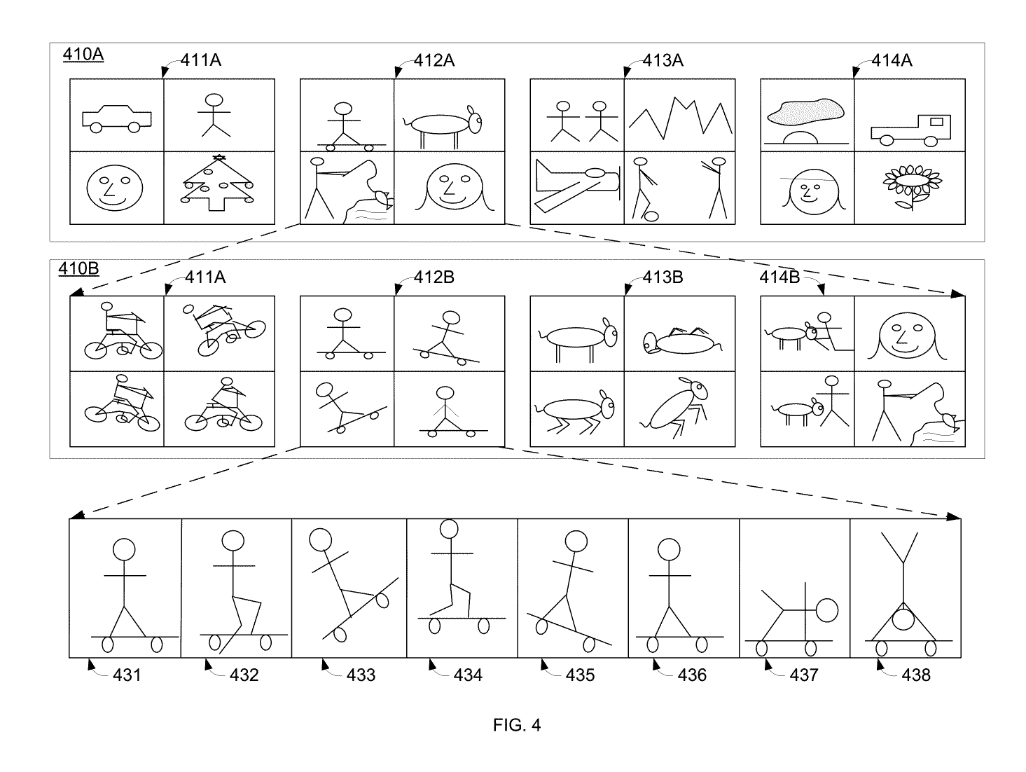

FIG. 4 is an illustration of changes in a photograph album window as different levels or timeline scales are activated. In one embodiment, a photograph album window 410 includes thumbnail indicators 411, 412, 413 and 414. Photograph album window 410 configuration at one level “A” is shown as photograph album window 410A and at a another level “B” is shown as photograph album window 410B. The configuration of thumbnail indicators 411, 412, 413 and 414 corresponding to level A are shown as 411A, 412A, 413A and 414A and at level B are shown as 411B, 412B, 413B and 414B.

As illustrated in FIG. 4, thumbnail indicator 411A can include photograph images of a car, a person, a face, and a tree. Thumbnail indicator 412A can include photograph images of a person riding a skate board, a person fishing a dog and a person's face. Thumbnail indicator 413A can include photograph images of a group of people, a mountain range, an airplane and people playing soccer. Thumbnail indicator 414A can include photograph images of a sunset and cloud, a truck, a person with a hat and a flower. A move to another timeline scale or level B can be initiated by clicking on thumbnail indicator 412A.

As illustrated in FIG. 4, thumbnail indicator 411B can include photograph images of a person riding a bicycle in various positions (e.g., sitting straight up, front wheel off the ground, back wheel off the ground, both wheels on the ground rider leaning forward, etc.). Thumbnail indicator 412B can include a photograph images of a person riding a skate board in various positions (e.g., standing straight up arms out, back wheel off the ground, front wheel off the ground, standing straight up arms down, etc.). Thumbnail indicator 413B can include a photograph images of an animal (e.g., dog, cat, etc.) in various positions (e.g., standing up, laying on back, crouched down, jumping up, etc. Thumbnail indicator 414B can include various photograph images (e.g., person petting animal, person's face, person playing with animal, person fishing, etc). A move to actual photographs can be initiated by clicking on thumbnail indicator 412B.

Activation or trigger of thumbnail indicator 412B can lead to presentation of photographs. For example, photograph 431 is a person standing on a skateboard. Photograph 432 is a person pushing the skateboard. Photograph 433 is a person riding a skateboard front wheels up. Photograph 434 is a person jumping while riding a skateboard. Photograph 435 is a person riding a skateboard back wheels up. Photograph 436 is a person standing on a skateboard. Photograph 437 is a person laying on a skateboard. Photograph 438 is a person standing on head while riding a skateboard.

In one exemplary implementation, a photograph album has 232 photographs associated with the car, 120 photographs associated with the person (e.g. at a birthday party, sporting event, etc.), 13 photographs associated with the person's face, and 141 photographs associated with the tree on a nature walk. There can be 15 photographs associated with the person riding a skate board, 45 associated with the person riding a bike, 175 photographs associated with the person fishing on a fishing trip vacation, 182 photographs associated with the dog, and 32 photographs associated with the other person's face. The photograph album can also include 250 photographs associated with the photograph of a group of people at a wedding, 87 photographs associated with the trip in the mountain range, 24 photographs associated with the airplane and 75 photographs associated with the people playing soccer. In addition, the photograph album has 48 photographs associated an evening at the beach with the sunset and cloud, 20 photographs associated with the truck, 134 photographs associated with the person with a hat at a sporting event, and 19 photographs associated with the a flower

A user interested in finding photographs related to activities involved with a child riding a bike and riding a skateboard can begin by initiating “opening” of the photograph album which results in level A of FIG. 4 being presented in the photograph album window. A quick look indicates the person riding the skate board in thumbnail indicator cluster 412 A. Activation of thumbnail indicator cluster 412A activates level B in the photograph album window. Activation of thumbnail indicator cluster 412B brings up the photographs 413 through 438 of the person skateboarding in level C. Thus, a user can efficiently browse over or search through the over 1600 photographs included in the photograph album to reach the photographs of interest, while using the relatively small photograph album window consistent with the small form factor of the mobile device.

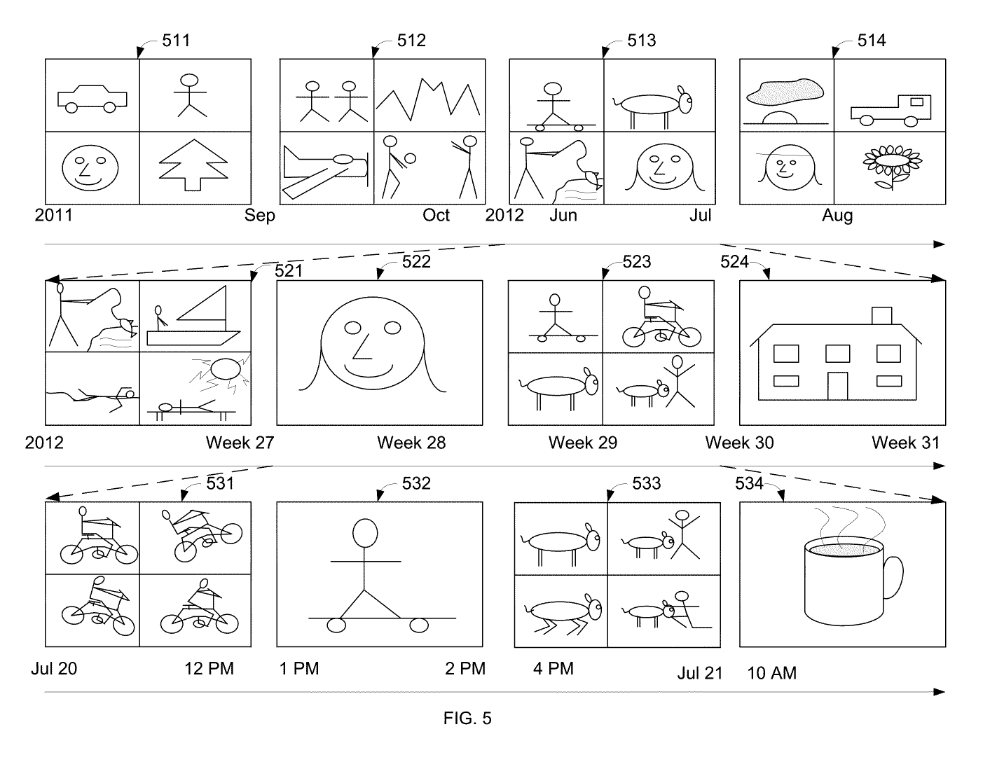

FIG. 5 is an illustration of changes in a photograph album window as different levels are activated. Thumbnail indicators 511 through 514 are presented at a first timeline scale of months. Thumbnail indicators 521 through 524 are presented at a second timeline scale of weeks. Thumbnail indicators 531 through 534 are presented at a third timeline scale of hours. Thumbnail indicator 511 can include photograph images of a car, a person, a face, and a tree. Thumbnail indicator 513 can include photograph images of a person riding a skate board, a person fishing a dog and a person's face. Thumbnail indicator 512 can include photograph images of a group of people, a mountain range, an airplane and people playing soccer. Thumbnail indicator 514 can include photograph images of a sunset and cloud, a truck, a person with a hat and a flower. A move to another timeline scale or level can be initiated by clicking on thumbnail indicator 513. Thumbnail indicator 521 can include photograph images of a person fishing, a person sailing a boat, a person swimming and a person sunbathing. Thumbnail indicator 522 can include a photograph image of a persons face. Thumbnail indicator 523 can include photograph images of a person riding a skate board, a person riding a bike, a dog, and a person playing with the dog. Thumbnail indicator 524 can include a photograph image of a house. Thumbnail indicator 531 can include photograph images of a person riding a bicycle in various positions (e.g., sitting straight up, front wheel off the ground, back wheel off the ground, both wheels on the ground rider leaning forward, etc.). Thumbnail indicator 532 can include a photograph image of a person riding a skateboard standing straight up. Thumbnail indicator 533 can include photograph images of a dog and a person playing with the dog. Thumbnail indicator 534 can include a photograph image of a cup of coffee.

There are a variety of mechanisms for changing the timeline scales. Various user interfaces can be utilized to change the timeline scale. The user can also quickly change the timeline scale using “pinch” gestures (e.g., closing or opening pinch movements, etc.), as though to “zoom” between timeline scales. The user can inspect the contents of a photograph cluster by tapping its thumbnail indicator. The contents of the inspected photograph cluster can be displayed in a variety of presentations. The presentations can include either a traditional grid-based view or as a multi-scale timeline again depending on whether or not the photograph number in the photograph cluster exceeds a predetermined threshold.

The multi-scale timeline photograph clusters can be created in a variety of ways. In one embodiment, the photograph clusters are created by extracting time and content-based features from the photographs and performing an efficient one-step incremental photograph clustering algorithm on the extracted feature sets. Both time and visual features are used for photograph clustering and browsing the photograph album, which effectively complement each other to improve the system performance. The timestamp of each photograph is extracted from metadata associated with a photograph, and three types of visual features are extracted from each image: abag-of-words representation using SURF local descriptors (SURF BoW), a 64-bin uniform Lab color histogram, and the global grid-based color moment (GBCM) also in Lab color space. The SURF BoW uses a codebook of size 500, built by K-means photograph clustering of randomly sampled SURF descriptors over the photograph album. The 225-dim GBCM feature includes the first three color moments computed over 5×5 image grids. In one exemplary implementation, there is N different timeline scales, in which a full multi-scale timeline photograph clustering is performed initially and conducted over each timeline scale individually based on the spectral photograph clustering algorithm. When a new image is added, a fast one-step incremental spectral photograph clustering algorithm can be performed.

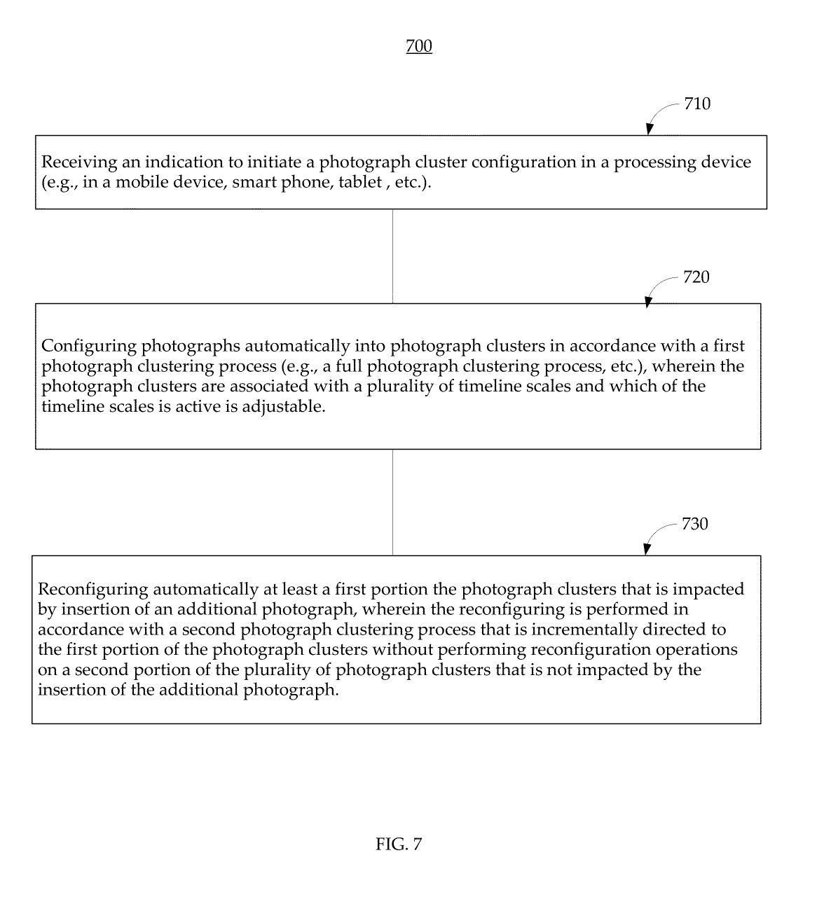

FIG. 7 is a flow chart of photograph of exemplary clustering method 700 in accordance with one embodiment of the present invention.

In block 710, an indication to initiate a photograph cluster configuration is received in a processing device.

In block 720, an initial photograph clustering is performed. The photographs are configured automatically into photograph clusters in response to receiving the indication in block 710 to initiate photograph clustering. The configuring is performed by the processing device in accordance with a first photograph clustering process, wherein the photograph clusters are associated with a plurality of timeline scales and which of the timeline scales is active is adjustable. The first photograph clustering process can include a full multi-scale timeline photograph clustering.

In one embodiment, a full multi-scale timeline photograph clustering includes assigning one or more photographs to a photograph cluster and associating the photograph cluster to one of a plurality of timeline scales or metric spans. A sparse similarity matrix S of the photograph album can be constructed on a timeline scale based on an aggregated similarity measure that is the convex combination of the K similarity functions defined on time and visual features:

S(yᵢ,yⱼ)−Σₖ₌₁^{K}αₖS_{K}(yᵢ,yⱼ) (1)

where αₖ≧0 for k=1, . . . , K and Σₖ₋₁^{K}α−1. Each entry S(yᵢ,yⱼ) in S is the similarity between point yᵢ and yⱼ for each feature, based on the Gaussian kernel:

S(yᵢ,yⱼ)−exp(−aₖd_{K}(yᵢ,yⱼ)²/σₖ²) (2)

where dₖ (•,) is the appropriate distance metric of feature k. Both the constants αₖ and the scaling factors αₖ are varied across different timeline scales in such a way that, for larger timeline scales, the time difference dominates since photographs taken far away from one another normally do not typically share similar contents and should not typically be clustered together. As the timeline scale becomes smaller, the weights of the content features increase. Similarity values below a sparsity threshold can be set to zero.

The initial spectral photograph clustering can be performed by solving the generalized eigenvalue system:

Lx=λDx (3)

where L is the graph Laplacian computed as L=D−A; A is a similarity matrix whose entries are Aᵢⱼ−S(yᵢ,yⱼ) if i≠j and Aᵢⱼ=0 and the degree matrix D is diagonal with Dᵢⱼ−Σⱼ. L and D are both symmetric. Clustering is associated with eigenvalues and the number of photograph clusters is automatically determined from the eigengap.

In block 720 at least a first portion of the photograph clusters that is impacted by insertion of an additional photograph are reconfigured automatically. The reconfiguring is performed in accordance with a second photograph clustering process that is incremental. The second photograph clustering process can be incrementally directed to the first portion of the photograph clusters without performing reconfiguration operations on a second portion of the plurality of photograph clusters that is not impacted by the insertion of the additional photograph. Performing the re-clustering incrementally can facilitate avoidance of performance issues associated with a full re-clustering. Even for a sparse L, efficient algorithms such as the Lanczos method can still require O(n^{1.5}) complexity to solve Equation (3). In one exemplary implementation, for mobile users, performing a full re-clustering of the entire photograph album every time a new image is added can be very inconvenient, especially for large n.

In one embodiment, an incremental spectral photograph clustering algorithm is utilized. The incremental spectral photograph clustering algorithm can utilize a well-known result from perturbation theory. Letting ΔL and ΔD denote the perturbations (e.g., change, etc.) to L and D, respectively, the first-order perturbation of the eigenvalue, Δλ, is given by:

$$Δ λ - \frac{{x}^{T} ( Δ L - λ Δ D ) x}{{x}^{T} Dx} \qquad ( 4 )$$

It has been shown that the perturbation of the eigenvector, Δx, can be obtained by solving the following linear system:

φΔx=h (5)

where φ−L−λD and h=(ΔλD+λΔD−ΔL)x. An assumption can be made that at a certain stage, n points have been photograph clustered already. When a new data point yₙ₊₁ is added, the perturbation ΔL is the difference between the new Laplacian, Lₙ₊₁, and a zero-padded Lₙ:

$$Δ L = {L}_{n + 1} - [ \begin{matrix}{L}_{n} & 0 \\ 0 & 0\end{matrix} ] - [ \begin{matrix}B & - b \\ - {b}^{T} & {b}^{T} 1\end{matrix} ] \qquad ( 6 )$$

where B−diag(b), 1 is a vector of all ones, and b is the n-dimensional vector whose i-th entry is the similarity between point yₙ₊₁ and yᵢ. Likewise, the perturbation of the degree matrix can be decomposed the same way:

$$Δ D = {D}_{n + 1} - [ \begin{matrix}{LD}_{n} & 0 \\ 0 & 0\end{matrix} ] - [ \begin{matrix}B & - b \\ - {b}^{T} & {b}^{T} 1\end{matrix} ] \qquad ( 7 )$$

Equations (6) and (7) are substituted into or put in Equation (4), giving the resulting:

$$Δ λ = ( 1 - λ ) \frac{{x}^{T} Bx}{{x}^{T} Dx} \qquad ( 8 )$$

As both B and D are diagonal, Equation (8) can be efficiently computed in O(n).

In one exemplary implementation, the perturbation method is a first-order approximation and errors may build up over time. A full re-clustering algorithm can be performed again (e.g., similar to the initial clustering, etc.) after a threshold or trigger number of updates or changes are implemented using an incremental re-clustering approach. The threshold or trigger number can be determined empirically.

In one embodiment, the new proposed incremental re-clustering can be referred to as a one-step incremental photograph clustering algorithm since one step is utilized to update each eigenvector. This is in comparison with some conventional incremental spectral photograph clustering methods, where the effect of adding each new photograph image is decomposed into a series of similarity changes in S, each change corresponding to solving a sparse linear system for each eigenvector. User interaction with the thumbnail indicator can trigger a change of content presented on the display, including a change of the representative photograph included in the thumbnail indicator.

As indicated above, a thumbnail indicator corresponding to a photograph cluster can be presented on a display screen. The thumbnail indicator can comprise one or more automatically selected representative images from the plurality of photographs included in the respective photograph cluster. In one exemplary implementation, the thumbnail indicator is constructed differently depending on the size of the photograph cluster. For photograph cluster sizes below a predetermined threshold T, the image with the highest degree centrality is automatically selected as the representative image. If the photograph cluster size is larger than T, multiple images (e.g., four, seven, etc.) are selected to create a collage type thumbnail indicator by first dividing the photograph cluster into four sub-photograph clusters using spectral photograph clustering, then finding the image with the highest degree centrality in each of the sub-photograph clusters.

Photograph clustering described herein can be compatible with photograph clustering based on both time and visual content and the number of photographs inside a photograph cluster can be “collapsed down”. The collapsing includes automatically removing near duplicate photographs. For fast near-duplicate detection, a cascade of binary classifiers can be used based on both time and visual features. It is appreciated a variety of binary classifiers can be utilized. First, by comparing timestamps of image or photograph pairs, most pairs that are not near-duplicates can be quickly ruled out. Then a relatively fast binary classifier using GBCM can be utilized to further rule out non-near-duplicates. The remaining pairs are finally classified by a binary classifier using the SURF BoW features. These classifiers are trained offline using a set of ground-truth near-duplicate images and are tuned towards a low rate of false positives, so that the chance of collapsing non-near-duplicate images is kept very low. Each group of near-duplicate images is treated as one image for photograph clustering and browsing (e.g., whose features are the average timestamp and visual features of the entire group, etc.).

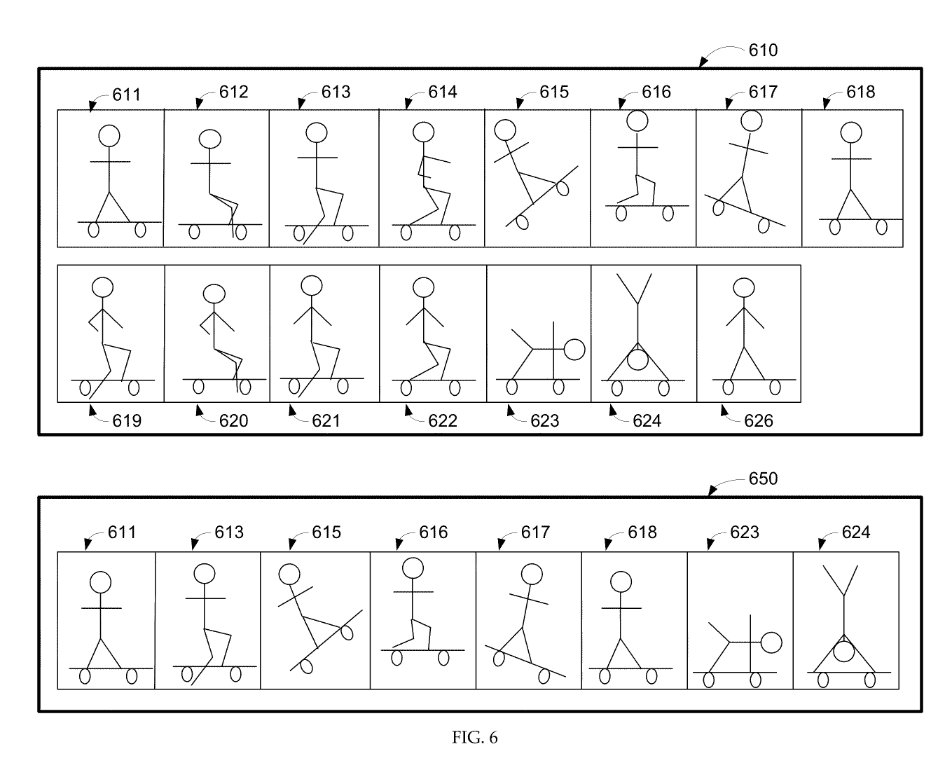

FIG. 6 is a block diagram illustration of an exemplary photograph cluster 610 and the collapsed down photograph cluster set 650. Photograph cluster 610 includes photographs 611 through 624 associated with a person riding a skateboard. Collapsed down photograph cluster set 650 includes photographs 611, 613, 615, 616, 617, 618, 623 and 624. FIGS. 612, 614, and 619 through 622 associated with a person propelling the skateboard are not included in collapsed down photograph cluster set 650 as they are similar to photograph 613 of a person propelling the skateboard. FIG. 626 associated with a person standing on the skateboard are not included in collapsed down photograph cluster set 650 as it is similar to photographs 611 and 618 of a person propelling the skateboard. The collapsed version of the photographs can be displayed.

The new implementation one-step incremental re-clustering can be dozens of times faster on average in some implementations than some conventional methods. In one exemplary implementation, the data associated with photographs in a photograph album is photograph clustered on four different timeline scales (i.e. N=4). The top timeline scale is over the whole collection. For smaller timeline scales, the image collection is divided up into chunks spanning a single month, week, or day, and each chunk is then photograph clustered separately. An added benefit of such division is the further computation speedup, since spectral photograph clustering has super-linear complexity. The data sets for a couple of photograph albums is very similar to characteristics of personal photograph albums on mobile devices. The data set characteristics criteria include a time span that is evenly distributed (e.g., a time span that covers a year distribution, etc.) and content that does not include a lot of post-processed images. The first dataset 1 has 2092 photographs taken over a period of 40 months, and the second dataset 2 has 3442 photographs taken over a period of 13 months.

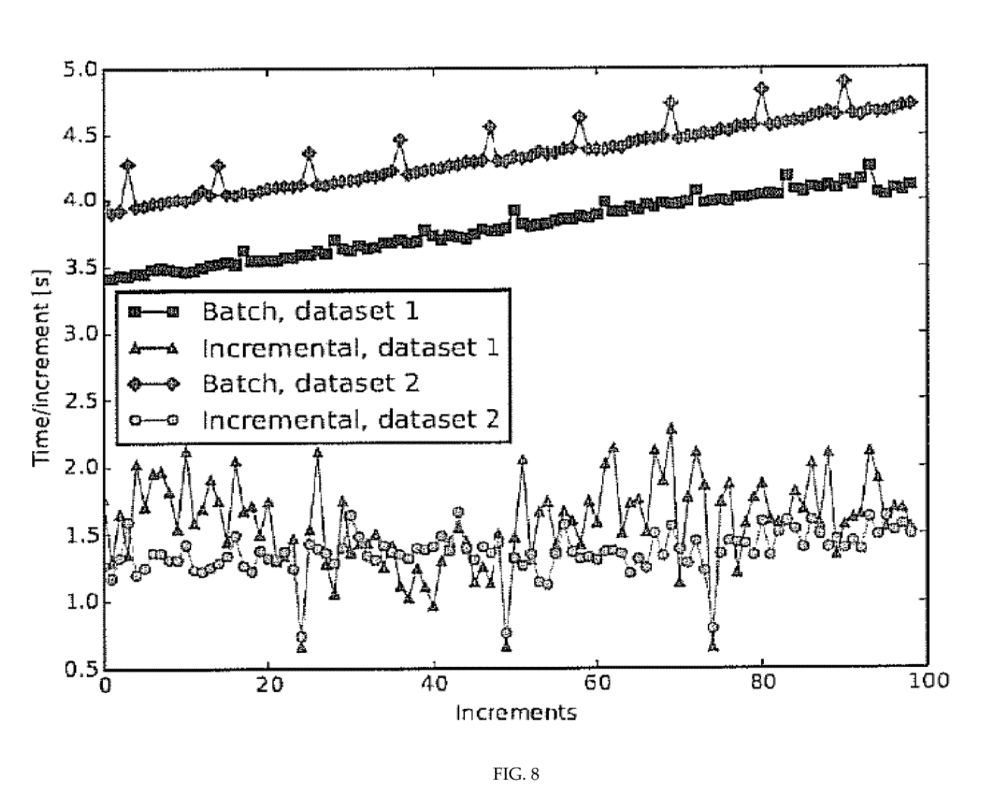

Performance of the incremental photograph clustering algorithm can be evaluated by comparing the photograph clustering quality and speed with regular full spectral photograph clustering algorithm when a new image is added. The quality is evaluated using normalized mutual information (NMI) compared with batch spectral photograph clustering. That is, a batch spectral photograph clustering of the entire dataset is used as the ground truth, and the incrementally photograph clustered dataset is compared at different stages to the ground truth using NMI. The NMI measures how similar the incremental result is to the batch result of the entire dataset. In the present example using the first dataset 1 and the second dataset 2, the incremental photograph clustering becomes more unlike the ground truth after each step due to the approximation of first order perturbation. This is remedied by rerunning batch photograph full re-clustering periodically to limit the error accumulation. The number of updates to run before rerunning the batch version full re-clustering is chosen to balance the trade-off between performance and speed. The algorithm performs considerably better on the second dataset 2 than the first dataset 1. The difference reflects the higher sparsity of dataset 1, since the system in eqn. 5 becomes more ill-conditioned as the Laplacian becomes sparser. FIG. 8 shows a graph of an example speed comparison of incremental photograph clustering and batch photograph clustering when one photograph is added. The FIG. 8 graph shows that while the time lapse per increment increases with a run of the batch version of the full re-clustering, the incremental version stays nearly constant.

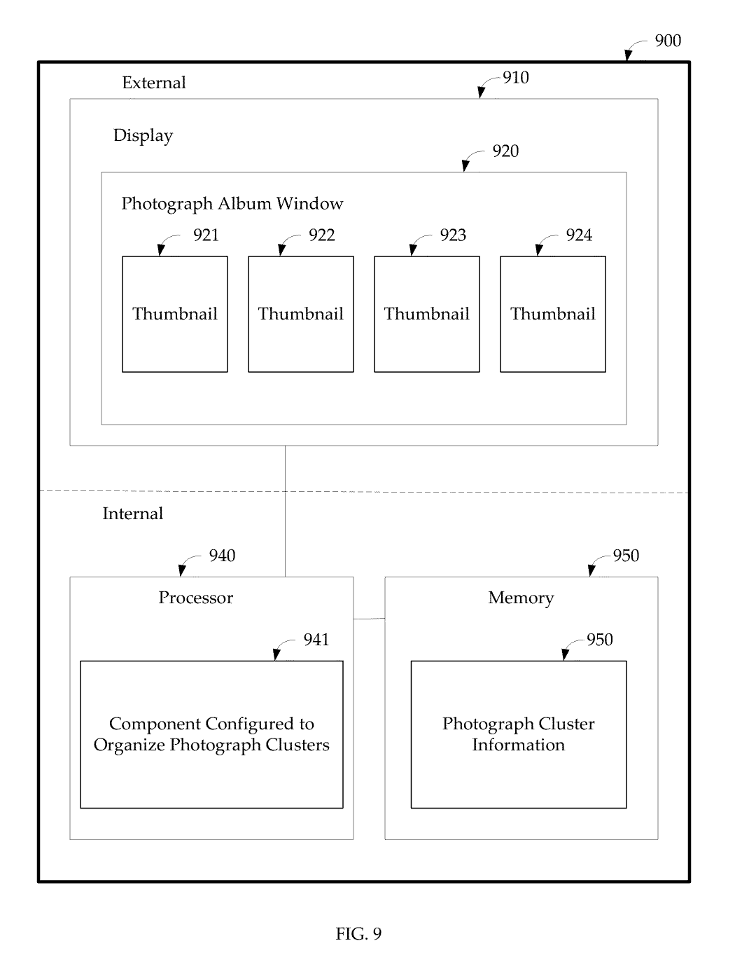

FIG. 9 is a block diagram of an exemplary apparatus 900 in accordance with one embodiment. Apparatus 900 can implement photograph browsing processes or methods (e.g., similar to photograph browsing method 200, etc.) and photograph clustering processes or methods (e.g., similar to photograph clustering method 700, etc.). Apparatus 900 includes a display 910, a processing component 940, and a memory component 950. In one embodiment, processing component 930 is configured to perform operations associated with organizing the photograph album within a multi-scale timeline framework that includes a plurality of timeline scales, in which the photograph album is configured into a plurality of photograph clusters and granularity of a resulting configuration of the photograph album into the plurality of photograph clusters corresponds to the granularity of one of the plurality of timeline scales. Memory 950 is configured to store information and instructions associated with a photograph album and photograph clusters. Display 910 is configured to present a user interface in accordance with directions from the processor, wherein the user interface includes a thumbnail indicator configured to enable a user to initiate a switch between one of the plurality of timeline scales to another one of the plurality of timeline scales and correspondingly change association of the thumbnail indicator from one of the plurality of photograph clusters to another one of the plurality of photograph clusters. Display 910 includes photograph album window 920 which includes thumbnail indicators 921, 922, 923, and 924. Display 920 can be an interactive display component. A user can use pinch gesture or buttons on the screen to zoom in/out the timeline scales, and tap the photograph cluster thumbnail indicators to inspect images in a particular photograph cluster.

The apparatus 900 can be a mobile device. Inclusion of the photograph in one of the plurality of photograph clusters can be determined by a full photograph cluster process that includes spectral photograph clustering operations. An additional photograph is included in the photograph album and inclusion of the additional photograph in the plurality of photograph clusters can be determined by incremental photograph clustering operations. The inclusion of a photograph in one of the plurality of photograph clusters is also determined at least in part by a proximity in time that an image is captured in another photograph included in the one of the plurality of photograph clusters. The inclusion of the photograph in the one of the plurality of photograph clusters can also be determined at least in part by visual content features of the photograph.

Photograph album browsing window 920 is associated with the photograph album and the photograph browsing window includes at least one thumbnail indicator that is operable to trigger a switch from a first one of the plurality of photograph clusters configured in accordance with a first one of the plurality of timeline scales to at least a second one of the plurality of photograph clusters configured in accordance with a second one of the plurality of timeline scales. At least one representative photograph is automatically selected from those included in the at least one of the plurality of photographs, and the at least one representative photograph is associated with the at least one thumbnail indicator. The at least one representative photograph is associated with a photograph cluster. A span of time is associated with one of the plurality of photograph clusters is adjustable.

Embodiments described herein may be discussed in the general context of computer-executable instructions, such as program modules, residing on some form of computer-readable storage medium executed by one or more computers or other devices. By way of example, and not limitation, computer-readable storage media may comprise non-transitory computer-readable storage media. Non-transitory computer-readable storage media includes all computer-readable media except for a transitory, propagating signal. Computer-readable storage media includes volatile and nonvolatile, removable and non-removable media implemented in any method or technology for storage of information such as computer-readable instructions, data structures, program modules or other data. Generally, program modules include routines, programs, objects, components, data structures, etc., that perform particular tasks or implement particular abstract data types. The functionality of the program modules may be combined or distributed as desired in various embodiments.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

1. An apparatus comprising:
a processor that automatically builds a plurality of photograph clusters that are associated with a plurality of timeline scales which are adjustable, wherein inclusion of a photograph in one of the plurality of photograph clusters is determined at least in part by a time an image is captured in the photograph and the plurality of timeline scales, the photograph is included in a photograph album and the processor initiates presentation of information associated with the photograph album in accordance with at least one of the plurality of photograph clusters;
a memory that stores information and instructions associated with a photograph album; and
a display that presents the information associated with the photograph album including a photograph album browse window, wherein the photograph album browse window includes at least one thumbnail indicator that is operable to trigger a switch from a first one of the plurality of photograph clusters associated with a first one of the plurality of timeline scales to at least a second one of the photograph clusters associated with a second one of plurality of timeline scales.

2. The apparatus of claim 1 wherein the apparatus is a mobile device.

3. The apparatus of claim 1 wherein the inclusion of the photograph in one of the plurality of photograph clusters is determined by a full photograph cluster process that includes spectral photograph clustering operations.

4. The apparatus of claim 3 wherein an additional photograph is included in the photograph album and inclusion of the additional photograph in the plurality of photograph clusters is determined by incremental photograph clustering operations.

5. The apparatus of claim 1 wherein the inclusion of the photograph in one of the plurality of photograph clusters is also determined at least in part by a proximity in time that an image is captured in another photograph included in the one of the plurality of photograph clusters.

6. The apparatus of claim 1 wherein the inclusion of the photograph in the one of the plurality of photograph clusters is also determined at least in part by visual content features of the photograph.

7. The apparatus of claim 1 wherein a photograph album browsing window is associated with the photograph album and the photograph browsing window includes at least one thumbnail indicator that is operable to trigger a switch from a first one of the plurality of photograph clusters configured in accordance with a first one of the plurality of timeline scales to at least a second one of the plurality of photograph clusters configured in accordance with a second one of the plurality of timeline scale.

8. The apparatus of claim 1 wherein at least one representative photograph is automatically selected from those included in the at least one of the plurality of photographs, and the at least one representative photograph is associated with the at least one thumbnail indicator.

9. The apparatus of claim 8 wherein the at least one representative photograph is associated with a photograph cluster.

10. The apparatus of claim 1 wherein a span of time is associated with one of the plurality of photograph clusters is adjustable.

11. A photograph clustering method in a mobile device, the method comprising:
receiving an indication to initiate a photograph cluster configuration in a processing device;
configuring photographs automatically into photograph clusters in response to receiving the indication to initiate photograph clustering, the configuring performed by the processing device in accordance with a first photograph clustering process, wherein the photograph clusters are associated with a plurality of timeline scales and which of the timeline scales is active is adjustable; and
reconfiguring automatically at least a first portion of the photograph clusters that is impacted by insertion of an additional photograph, wherein the reconfiguring is performed in accordance with a second photograph clustering process that is incrementally directed to the first portion of the photograph clusters without performing reconfiguration operations on a second portion of the plurality of photograph clusters that is not impacted by the insertion of the additional photograph.

12. The photograph clustering method of claim 11 enabling an alternative in which the first configuration process is a full photograph clustering process and the second configuration process is an incremental photograph clustering process.

13. The photograph clustering method of claim 11 enabling an alternative in which the first configuration process is a full spectral photograph clustering process and the second configuration process is an incremental spectral photograph clustering process.

14. The photograph clustering method of claim 11 enabling an alternative in which the second photograph clustering process is a one step incremental photograph clustering process in which an eigenvector is updated.

15. A mobile device comprising:
a processor that organizes a photograph album within a multi-scale timeline framework that includes a plurality of timeline scales, in which photographs of the photograph album are configured in a plurality of photograph clusters and granularity of a resulting configuration of the plurality of photograph clusters corresponds to the granularity of the plurality of timeline scales;
a memory configured to store information and instructions associated with a photograph album; and
a display configured to present a user interface in accordance with directions from the processor, wherein the user interface includes a thumbnail indicator configured to enable a user to initiate a switch between one of the plurality of timeline scales to another one of the plurality of timeline scales and correspondingly change association of the thumbnail indicator from one of the plurality of photograph clusters to another one of the plurality of photograph clusters.

16. The mobile device of claim 15 wherein the thumbnail indicator includes a photograph representative of at least some of the photographs included in a photograph cluster.

17. The mobile device of claim 16 wherein the photograph representative of at least some of the photographs included in one of the plurality of photographs photograph clusters is automatically selected based at least in part on time and content similarity to at least some of the photographs in the one of the plurality of photographs.

18. The mobile device of claim 15 wherein user interaction with the thumbnail indicator triggers a change of content presented on the display, including a change of the representative photograph included in the thumbnail indicator.

19. The mobile device of claim 15 wherein the display is configured to present a collapsed version of photographs included in at least one of the plurality of photograph cluster.

20. The mobile device of claim 15 wherein configuration of the plurality of photograph clusters includes an initial full photograph clustering process and an incremental photograph clustering process if a new photograph is added to or deleted from the photograph album.
